(19) United States
(12) Patent Application Publication
(10) Pub. No.: US 2026/0169312 A1
(43) Pub. Date: Jun. 18, 2026

(54) FRAME ILLUMINATION ON EYEWEAR

(71) Applicant: Raven Resonance Inc., San Francisco, CA (US)

(72) Inventors: Ivan France, Saratoga, CA (US); Ernest Rehmatulla Post, San Francisco, CA (US); Curtis Aumiller, San Jose, CA (US); Thomas Suarez, San Francisco, CA (US)

(73) Assignee: Raven Resonance Inc., San Francisco, CA (US)

(21) Appl. No.: 19/419,062

(22) Filed: Dec. 14, 2025

Related U.S. Application Data
(60) Provisional application No. 63/734,738, filed on Dec. 16, 2024.

(51) Int. Cl. G02C 11/04; G02C 11/00

(52) U.S. Cl. CPC G02C 11/04; G02C 11/10

(57) ABSTRACT

An eyewear or smart glasses apparatus having a frame having one or more lenses, a light source, and a light-transmitting portion of the frame optically coupled to the light source. The light-transmitting portion emits light in at least one of an outward direction away from a wearer and an inward direction toward the wearer. The light-transmitting portion preferably is a lower rim section extending around a lower perimeter of the lenses. A guide element transmits light from the light source to the light-transmitting portion, with the guide element being at least one of a light tube, a fiber optic element, or a diffusion element configured to create a gradient illumination pattern. An illumination controller is connected to the light source and generates distinct illumination patterns in the light-transmitting portion for signaling different information, either outwardly for signaling others or inwardly for signaling the wearer.

### RELATED APPLICATION

This patent application relates to and claims priority from U.S. Provisional Patent Application Ser. No. 63/734,738 entitled “Frame Illumination on Wearable Electronic Devices” filed Dec. 16, 2024 and is incorporated herein by reference including its specification.

### FIELD OF THE INVENTION

The present invention is directed to a system and apparatus for selective and controllable illumination of a frame on eyewear, including wearable electronic such as smart glasses and similar devices. The system and apparatus are designed to allow for illumination of part or all of the frame of the eyewear. In the case of smart glasses, the rim frame around the lenses may be particularly constructed such that a lower part of such rim frame may be selectively illuminated, whether such illumination is on/off, in one or more colors, in a pattern or sequence, or directed inwardly or outwardly.

### BACKGROUND OF THE INVENTION

Wearable eyewear, in particular smart glasses, has become much more common in recent years. In the case of smart glasses, such typically display information on the lenses for the user to see or read. Oftentimes, there is a need for such devices to display information or signals for other than the user. For example, if the user wants to emote or otherwise signal a message to people in his/her vicinity, it would need to display information someplace other than on the lenses.

In addition, there may be some uses of eyewear, where it would be helpful if the user could illuminate rearward of the lenses—whether to illuminate the user's eyes or face. Such illumination could potentially provide additional functionality and/or security, subject to appropriate programming and construction.

Accordingly, there is a need for an eyewear frame that includes structure and programming for illuminated frames, either in whole or in part, with such illumination allowing for multi-colors, patterns or sequences, and/or forward/rearward options. The present invention fulfills these needs and provides other related advantages.

### SUMMARY OF THE INVENTION

The present invention has been developed in response to the present state of the art, and in particular, in response to the needs and wants of distributors and consumers. The inventive eyewear, particularly in the form of smart glasses, includes controllable frame elements, around a portion or the entire perimeter of the lenses.

The controllable frame elements are preferably sections of the device that can be illuminated, potentially in a controlled way to change brightness, color, or lighting pattern. When unpowered, the illumination sections preferably appear as slightly frosted or clear. The frame elements may be placed elsewhere, but in the preferred embodiment they are positioned in the lower part of the lens frame, i.e., underneath the eyes. In a particularly preferred embodiment, the inventive frame elements extend from the nose bridge pads to the other side of the bottom edge of the lenses, proximate to the temple.

Many such glasses frames use thin or transparent material underneath the lenses to reduce the visual weight of the glasses and block as little of the wearer's face as possible. Such construction lends itself to the present invention by incorporating illuminating elements within the frame elements. By integrating small controllable light sources (such as LEDs or a small display panel) in the frame, the frame elements illumination sections can be lit up to provide a variety of functions.

The selective illumination of the frame elements can be used to provide information to the user such as status of the device or to signal notifications. The selective illumination can also be used to provide information to third parties about the user's intent or status, i.e., emoting. In some embodiments these two functions can even be separated such that the user can view the inner illumination privately, while broadcasting a different outward illumination to others.

The design relies on controlling the light reflections within the frame elements such as in a light pipe. The shape of a clear medium can be constructed such that when emitted light hits a wall, instead of passing through, it is totally internally reflected along the light pipe. Then variably spaced surface features can extract the light along the pipe such that the perceived illumination is even along the entire length of the section.

In a preferred embodiment, the present invention is directed to an eyewear apparatus having a frame configured to support at least one lens. The frame includes at least one light source disposed in or on the frame, and at least one light-transmitting portion of the frame optically coupled to the at least one light source. The at least one light-transmitting portion is configured to emit light in at least one of an outward direction away from a wearer and an inward direction toward the wearer.

The at least one light-transmitting portion preferably is a lower rim section extending around a lower perimeter of the frame configured to support the at least one lens. The frame is preferably configured to support a first lens and a second lens and the lower rim section extends around a lower perimeter of each portion of the frame configured to support the first lens and the second lens.

The at least one light-transmitting portion may consist of a transparent material or a translucent material. The at least one light source may be disposed in at least one of a temple portion of the frame, a bridge portion of the frame, or a junction between the frame and a temple arm. The eyewear may further include at least one light guide element configured to transmit light from the at least one light source to the at least one light-transmitting portion. The at least one light guide element is preferably at least one of a light tube, a fiber optic element, or a diffusion element configured to create a gradient illumination pattern.

The eyewear may further include an illumination controller operationally connected to the at least one light source and configured to generate distinct illumination patterns in the light-transmitting portion for signaling different information. The at least one light-transmitting portion is preferably a first light-transmitting portion configured to emit light outwardly for signaling others, and a second light-transmitting portion configured to emit light inwardly for signaling the wearer.

In another embodiment, the present invention is also directed to a smart glasses apparatus having a frame configured to support at least one lens, wherein the frame also has at least one electronic component for providing computer processing functionality. At least one light source is disposed in or on the frame and at least one light-transmitting portion of the frame is optically coupled to the at least one light source. An illumination controller is electrically connected to the at least one light source, wherein the electronic component is operationally connected to the illumination controller so as to selectively illuminate the at least one light-transmitting portion to emit light as a signal. The at least one electronic component is at least one of a wireless communication module, a processor, a sensor, a camera, a display element, or an audio device. Other features described above are also applicable to this embodiment.

The present invention is also directed to a method of providing visual signals using eyewear. The method begins with providing an eyewear apparatus having a frame with at least one light-transmitting portion in the form described above. The next step involves activating at least one light source optically coupled to the at least one light-transmitting portion. The next step involves emitting light through the at least one light-transmitting portion in at least one of an outward direction to signal others and an inward direction to signal a wearer of the eyewear.

Other features and advantages of the present invention will become apparent from the following more detailed description, taken in conjunction with the accompanying drawings, which illustrate, by way of example, the principles of the invention.

### BRIEF DESCRIPTION OF THE FIGURES

These and other features and advantages of the present invention will become appreciated, as the same becomes better understood with reference to the specification, claims and drawings herein:

FIG. 1 is an elevated perspective view of eyewear of the type contemplated in the present invention;

FIG. 2A is an elevated front view of the eyewear of FIG. 1 with one lower light rim illuminated;

FIG. 2B 3 is an elevated front view of the eyewear of FIG. 1 with both lower light rims illuminated;

FIG. 2C is an elevated front view of the eyewear of FIG. 1 with one entire light rim illuminated;

FIG. 2D is an elevated front view of the eyewear of FIG. 1 with both entire light rims illuminated;

FIG. 3 is a side cut-away view through one lens frame of the eyewear of FIG. 1 illustrating an embodiment of a light tube;

FIG. 4 is a close-up view of an illuminated light rim as shown in FIG. 2A, illustrating an embodiment of a light tube;

FIG. 5 is a front view of a lens frame with light rim as shown in FIG. 2A, illustrating another embodiment of a light tube;

FIG. 6A is an elevated front view of a frame with light rim as shown in FIG. 2A, using a light tube made from smart film that is unpowered; and

FIG. 6B is an elevated front view of a frame with light rim as shown in FIG. 2A, using a light tube made from smart film that is powered.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” “inner” or “outer,” and “medial” or “lateral” may be used herein to describe one element's relationship to other elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The invention described herein is primarily concerned with the structure and apparatus of illuminated frame elements in eyewear, particularly wearable electronic devices such as smart glasses and similar wearable technology. Features of wearable devices and electrical connections to batteries are intended to conform to the current state of the art of such features, or as such state of the art may develop in the future.

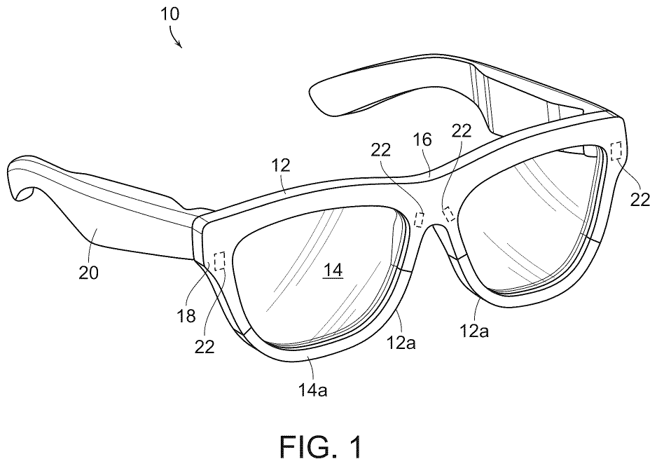

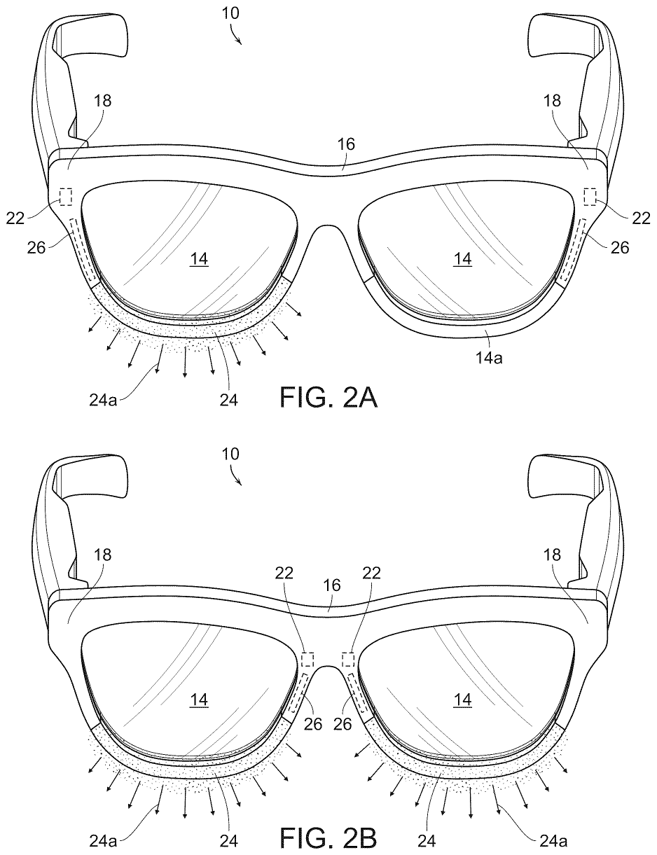

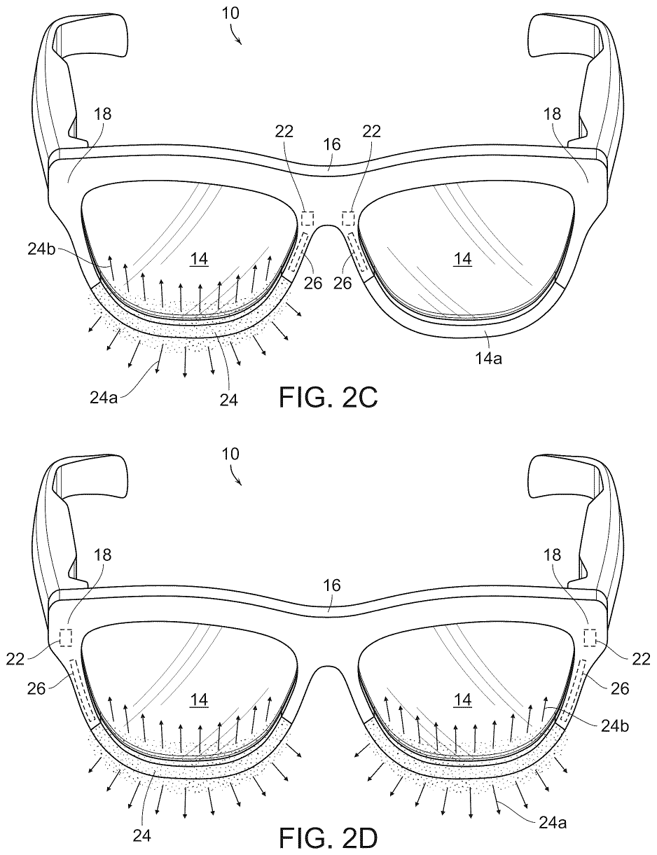

As shown in FIGS. 1 and 2A, the present invention is directed to an eyewear apparatus 10 generally referred to by reference numeral 10. The eyewear apparatus 10 may consist of standard glasses, smart glasses, or another form of eyewear comprising a frame 12 configured to support at least one lens 14, but typically two lenses 14, with a bridge portion 16, a temple portion 18, and temple arms 20, as is found in typical eyewear. In some embodiments, the eyewear apparatus 10 may comprise all of the above components except for the lenses 14, e.g., providing all the features described herein without an actual lens 14 in the frame 12, or may be configured so as to support only one lens 14 to correspond to only one eye of a user (not shown).

As described herein, the inventive eyewear 10 further comprises a light source 22 on or in the frame 12. As shown in FIG. 1, the light source 22 may be disposed at both the bridge portion 16 and the temple portion 18, or at a junction between the temple portion 18 and a temple arm 20 (not shown). As shown in FIGS. 2A-2D, the light source 22 may optionally be disposed at either one of the bridge portion 16 or the temple portion 18.

The light source 22 may consist of an sufficiently sized sources, including but not limited to LEDs, micro-LEDs, mini-LEDs, chip-on-board LEDs, side-emitting LEDs, RGB LEDs, flexible OLEDs, transparent OLEDs, OLED strips or ribbons, laser diodes, vertical-cavity surface-emitting lasers (VCSELs), micro laser modules, electroluminescent wire/panels/strips, printed electroluminescent materials, quantum dot LEDs, photo-excited quantum dots, edge-lit waveguides, and photonic integrated circuits. The light source 22 is preferably powered by a conventional battery arrangement as may be found on smart glasses or similar eyewear 10.

In the inventive eyewear 10, the majority of the frame 12 is preferably opaque, except for the selected frame elements, i.e., light transmitting portions 24, desired to be selectively illuminated. As described below, the selectively illuminated frame elements, e.g., light transmitting portions 24, are preferably disposed along the lower rim 14a of the perimeter frame 12a configured to support the lenses 14.

The frame 12 of the eyewear 10 preferably comprises a light transmitting portion 24 that is preferably the portion of the frame 12 that is configured to support the lens 14, i.e., the rim or perimeter frame 12a that would surround the lens 14. The light transmitting portion 24 may comprise part of or the entire perimeter frame 12a. When the light transmitting portion 24 comprises only a part of the perimeter frame 12a, it is preferably the lower rim or perimeter portion 14a—spanning approximately 50% of the perimeter frame 12a, or from proximate to the bridge portion 16 to the other side of the lens 14 proximate to the temple portion 18.

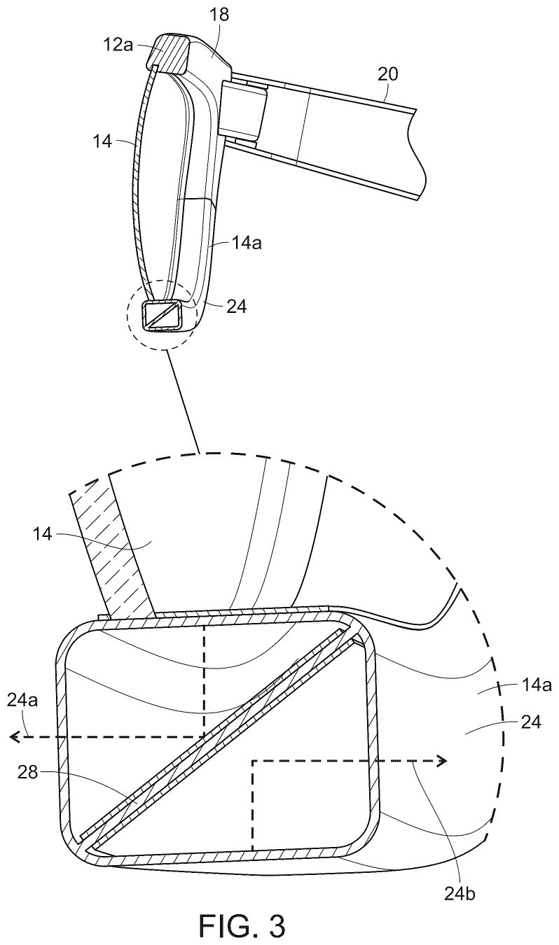

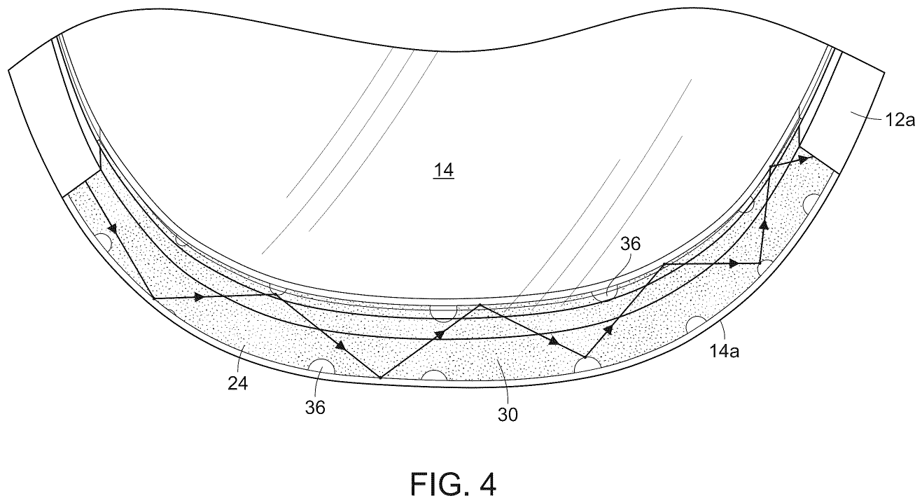

FIGS. 2A, 2B, 2C, 2D, and 3 illustrate variations on illumination applied to light transmitting portions 24 of the frame 12. The light transmitting portion 24 is preferably transparent, but at least translucent, so as to permit the passage of light. As mentioned above, the light source 22 that introduces light into the light transmitting portion 24 may be disposed near the bridge portion 16 or the temple portion 18, with some separation from the light transmitting portions 24 themselves. Depending on the separation distance, the device may also include a light guide element 26 arranged to convey the illumination from the light source 22 to the light transmitting portion 24, preferably on the interior of the perimeter frame 12a. As described above, the light transmitting portions 24 preferably extend along the lower rim 14a of the lenses 14 from proximate to the bridge portion 16 to proximate to the temple portion 18. Alternatively, light sources may be placed at the opposite end or at both ends of the light transmitting portions 24.

Whether provided with single or double light sources 22, such may be controlled separately or together—either as to one lens 14 or as to both lenses 14. FIG. 2A shows the lower rim portion 14a of one lens 14 illuminated. FIG. 2B shows the lower rim portion 14a of both lenses 14 illuminated. FIG. 2C shows the entire rim portion 12a of one lens 14 illuminated. FIG. 2D shows the entire rim portion 12a of both lenses 14 illuminated. FIG. 3 shows the lower rim portion 14a of at least one lens 14, with the illumination directed both outwardly 24a and inwardly 24b. FIG. 3 is provided to illustrate a particular construction of the light transmitting portions 24 to allow for inward and outward illumination, i.e., a structure for separating the light tube 30 into effectively two separate light pipes 30a, 30b—allowing for two separate effects. The cross-section illustrated in the close-up of FIG. 3 includes a diagonal divider 28—with or without reflective lining to separate the light transmitting portions 24 into two separate tubes 30a, 30b. Such construction allows for separate light paths for the benefit of the user and for the benefit of others viewing the user.

As mentioned, the inventive eyewear 10 further includes a light guide element 26 that is configured and oriented to direct illumination from the light source 22 to the light transmitting portion 24 of the frame 12. The light guide element 26 may consist of a light pipe, a light tube, fiber optic strands, diffusion films or coatings, micro-prism arrays, or holographic optical elements. As illustrated in FIG. 3, the light transmitting portion 24 may include a divider 28 preferably positioned diagonally, with reflectors on both sides of the light transmitting portion 24, so as to permit re-directing illumination either inwardly 24a (toward the wearer), outwardly 24b (away from the wearer), or both simultaneously, as illustrated in the expanded part of FIG. 3.

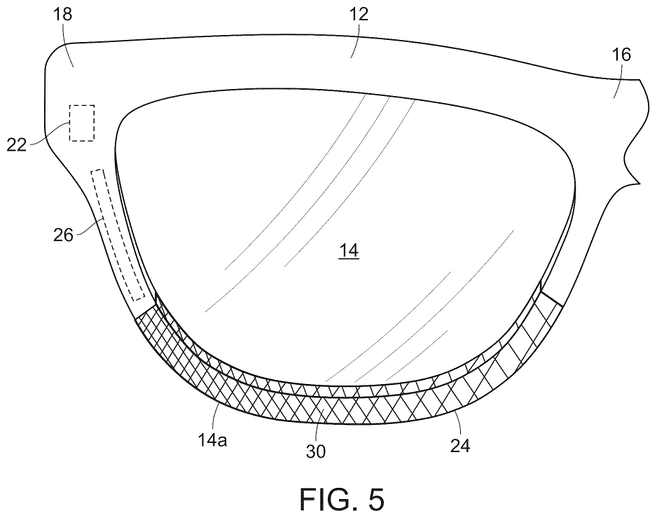

FIG. 4 illustrates a version of an illuminated lower rim 14a on eyewear 10, incorporating an embodiment of a light pipe or tube 30 as the light transmitting portion 24 of the frame 12. In this illustrated form, the light pipe or tube 30 has total internal reflection so as to keep the reflected light entirely within the tube from the inlet to the outlet. The inner core of such total internal reflection light tubes 30 has a high refractive index and the outer cladding has a low refractive index. In the frame elements for the inventive smart glasses, the inner core of the light tube 30 preferably includes variably spaced extraction features 36 or transmissive material such that the light is permitted to pass through. FIG. 5 illustrates another embodiment of the light tube 30 wherein the transmissive surface is progressively sanded (indicated by cross-hatching) from beginning to end so as to vary the amount of light extraction or transmission along the light transmitting portion 24.

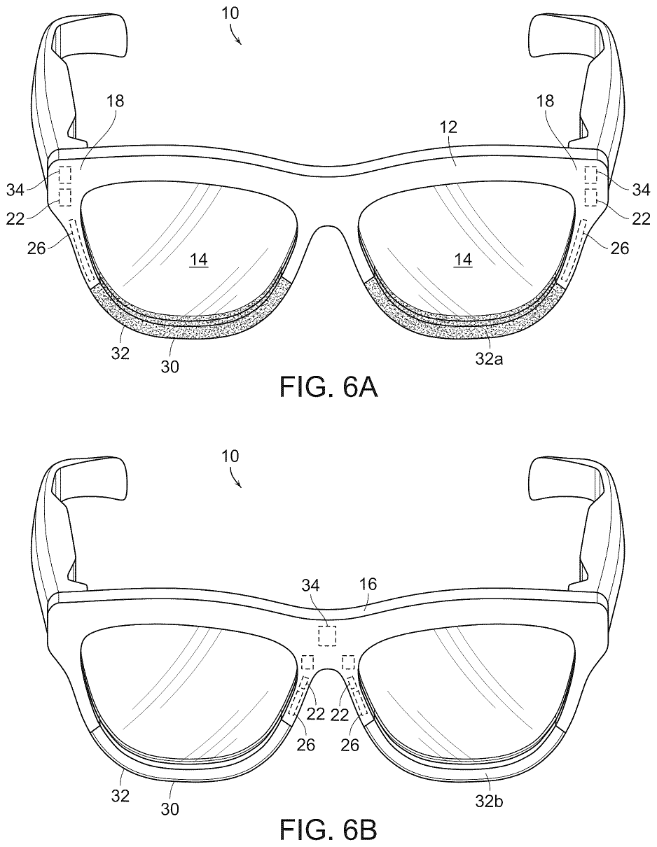

FIGS. 6A and 6B illustrate another embodiment of the light tube 30 that utilize a smart film 32 as the inner core thereof. The smart film 32 is configured to be opaque or non-transmissive when in an unpowered state 32a (FIG. 6A) and transparent or translucent when in a powered state 32b (FIG. 6B). In this way, the light transmitting portion 24 can be adjusted as to when and how much light is permitted to be extracted or transmitted.

An illumination controller 34 is preferably included with the eyewear 10. The illumination controller 34 is electrically connected to the light source 22 and, where applicable, to the light transmitting portion 24 and/or the light guide element 26, such as with a light tube 30 or smart film 32, to control its transmissivity or opacity, as described above. With the illumination controller 34 operationally connected to the light source 22, the illumination of different light transmitting portions 24 may be presented in the same colors, different colors, constant on, alternating on, switching on/off, long duration, short duration, or other varied patterns.

FIG. 2B illustrates a particular embodiment of the eyewear 10 with illuminated light transmitting portions 24 on the lower rims 14a, with the light source 22 placed in an upper, opaque section of the frame 12 proximate to the bridge portion 16. For clarity, the light sources 22 are visible in this illustration, but they would preferably not be visible through the use of appropriate opaque material in the frame 12 to conceal the light source 22 and reduce visual hotspots. FIG. 2B also illustrates sample light paths through the light transmitting portions 24 of the lower rims 14a. As described above and shown in FIGS. 2A and 2B, the separate light transmitting portions 24 may be controlled independently to illuminate only a single lens or both lenses with separate colors or patterns. The variations in illumination as to one lens, both lenses, different patterns, or different colors may find utility in smart glasses applications such as navigation, notifications/alerts, safety warning, etc.

An alternative construction of light transmitting portions 24 might include reflective designs similar to LED/LCD devices like TVs, where a side emitting LEDs is disposed near the bridge portion 16 as the light source 22. The side-emitting LED is preferably behind opaque frame 12 or a perimeter mask, with the light directed into a light guide plate with a backing of a reflective LCD assembly and a front micro-lens array, all behind a protective cover, wherein the reflective LCD assembly and light guide plate operate to pass a portion of the light along the tube 30 and reflect another portion of the light through protective cover effectively perpendicular to the initial direction of the light issued by the light source 22. Such construction allows for uniform illumination along the light transmitting section 24, even with the light source 22 is only at one end.

As shown in FIG. 5, a similar effect is used in the inventive eyewear 10 by polishing the surface of the light transmitting portion 24, and then lightly sanding a diffuse gradient onto the front surfaces achieves variable light extraction and even illumination across the entire length of the light transmitting portion 24. In particular, the light transmitting portion 24 is lightly sanded at the end adjacent to the light source 22—depicted with denser cross-hatching—to extract a small amount of light. Then, the light transmitting portion 24 is more heavily sanded at the end distal from the light source 22—depicted with less dense cross-hatching—to extract all remaining light and balance the brightness.

Other types of surface features, filters, or material additives may be used to produce a variety of effects other than simply brightness control. For example, stripes of color or glow in the dark pigment or dye. In addition, multiple light sources at the same end of the illuminated frame elements may be used to produce patterned effects along the frame section because the light can take different paths along the light pipe. In addition, a smart film material, e.g., polymer dispersed liquid crystal (PDLC), may be used as a section material, or as a surface film. FIGS. 6A and 6B illustrate how such smart film changes from transparent to frosted or opaque when a voltage is applied. For example, the smart film may be left transparent (FIG. 6B) in normal usage of the eyewear 10 and switched to frosted (FIG. 6A) when the light source 22 is illuminated. The smart film can be used to either appear as a normal frame element when not in use or to mute the light from the light transmitting portion 24 when charged.

Although several embodiments have been described in detail for purposes of illustration, various modifications may be made without departing from the scope and spirit of the invention.

1. An eyewear apparatus comprising:
a frame configured to support at least one lens;
at least one light source disposed in or on the frame; and
at least one light-transmitting portion of the frame optically coupled to the at least one light source, wherein the at least one light-transmitting portion is configured to emit light in at least one of an outward direction away from a wearer and an inward direction toward the wearer.

2. The eyewear apparatus of claim 1, wherein the at least one light-transmitting portion comprises a lower rim section extending around a lower perimeter of the frame configured to support the at least one lens.

3. The eyewear apparatus of claim 2, wherein the frame is configured to support a first lens and a second lens and the lower rim section extends around a lower perimeter of each portion of the frame configured to support the first lens and the second lens.

4. The eyewear apparatus of claim 1, the at least one light-transmitting portion comprising a transparent material or a translucent material.

5. The eyewear apparatus of claim 1, the at least one light source being disposed in at least one of a temple portion of the frame, a bridge portion of the frame, or a junction between the frame and a temple arm.

6. The eyewear apparatus of claim 1, further comprising at least one light guide element configured to transmit light from the at least one light source to the at least one light-transmitting portion.

7. The eyewear apparatus of claim 6, the at least one light guide element comprising at least one of a light tube, a fiber optic element, or a diffusion element configured to create a gradient illumination pattern.

8. The eyewear apparatus of claim 1, further comprising an illumination controller operationally connected to the at least one light source and configured to generate distinct illumination patterns for signaling different information.

9. The eyewear apparatus of claim 1, the at least one light-transmitting portion comprising a first light-transmitting portion configured to emit light outwardly for signaling others, and a second light-transmitting portion configured to emit light inwardly for signaling the wearer.

10. An smart glasses apparatus comprising:
a frame configured to support at least one lens, wherein the frame also has at least one electronic component for providing computer processing functionality;
at least one light source disposed in or on the frame;
at least one light-transmitting portion of the frame optically coupled to the at least one light source; and
an illumination controller electrically connected to the at least one light source, wherein the electronic component is operationally connected to the illumination controller so as to selectively illuminate the at least one light-transmitting portion to emit light as a signal.

11. The eyewear apparatus of claim 10, wherein the at least one electronic component comprises at least one of a wireless communication module, a processor, a sensor, a camera, a display element, or an audio device.

12. The eyewear apparatus of claim 10, wherein the at least one light-transmitting portion comprises a lower rim section extending around a lower perimeter of the frame configured to support the at least one lens.

13. The eyewear apparatus of claim 12, wherein the frame is configured to support a first lens and a second lens and the lower rim section extends around a lower perimeter of each portion of the frame configured to support the first lens and the second lens.

14. The eyewear apparatus of claim 10, the at least one light-transmitting portion comprising a transparent material or a translucent material.

15. The eyewear apparatus of claim 10, the at least one light source being disposed in at least one of a temple portion of the frame, a bridge portion of the frame, or a junction between the frame and a temple arm.

16. The eyewear apparatus of claim 10, further comprising at least one light guide element configured to transmit light from the at least one light source to the at least one light-transmitting portion.

17. The eyewear apparatus of claim 16, the at least one light guide element comprising at least one of a light tube, a fiber optic element, or a diffusion element configured to create a gradient illumination pattern.

18. The eyewear apparatus of claim 10, wherein the illumination controller is configured to generate distinct illumination patterns for signaling different information.

19. The eyewear apparatus of claim 10, the at least one light-transmitting portion comprising a first light-transmitting portion configured to emit light outwardly for signaling others, and a second light-transmitting portion configured to emit light inwardly for signaling the wearer.

20. A method of providing visual signals using eyewear, comprising the steps of:
providing an eyewear apparatus having a frame with at least one light-transmitting portion;
activating at least one light source optically coupled to the at least one light-transmitting portion; and
emitting light through the at least one light-transmitting portion in at least one of an outward direction to signal others and an inward direction to signal a wearer of the eyewear.
